(19) United States
(12) Patent Application Publication
(10) Pub. No.: US 2011/0150957 A1
(43) Pub. Date: Jun. 23, 2011

(54) Method Of Controlling Soil Insects

(75) Inventors: Wolfgang Wirth, Bergisch Gladbach (DE); Wolfgang Thielert, Odenthal (DE); Heike Hungenberg, Langenfeld (DE); Jean-Pierre Trijau, Lyon (FR)

(73) Assignee: Bayer CropScience AG, Monheim (DE)

(21) Appl. No.: 13/060,336

(22) PCT Filed: Aug. 26, 2009
(86) PCT No.: PCT/EP2009/006161

§ 371 Date: Feb. 23, 2011

(30) Foreign Application Priority Data
Aug. 27, 2008 (EP) 08163087.3
Dec. 19, 2008 (EP) 08172424.7

(51) Int. Cl. A01N 25/12; A01N 43/40; A01N 37/18; A01N 51/00; A01N 43/88; A01N 43/86; A01N 43/78; A01N 43/66; A01P 7/00

(52) U.S. Cl. 424/405; 514/357; 514/365; 514/471; 514/341; 514/342; 514/229.2; 514/226.8; 514/245

(57) ABSTRACT

The present invention relates to an insecticidal granular composition, comprising (a) at least one insecticide, selected from the group consisting of an enaminocarbonyl compound, a neonicotinoid, a tetronic acid derivative or a tetramic acid derivative compound, a carbamate compound, an organophosphate compound, a diamide compound, a pyrethroid compound and flonicamid; (b) optionally at least one moisture-retaining agent; and (c) vegetable meal.

The present invention relates to insecticidal compositions intended for controlling soil insects in their various developmental forms, and in particular compositions useful for controlling click beetles. The invention also relates to a method for controlling soil insects, in particular click beetles, by using said compositions and to the use of the above-mentioned compositions for controlling insects, in particular click beetles.

It is known in the art to cut a seed furrow with an upright shank or knife and simultaneously charge the furrow with fertilizers, insecticides or other active ingredients respectively compositions. This method is—inter alia—used for controlling click beetles.

Click beetles constitute a family of insects which are particularly harmful for certain crops, more particularly for maize, beet, sunflower, potato and rape crops. Their harmful character is all the more marked since the larval forms of click beetles can remain for very long periods in the soil, extending up to 5 years

Baits have indeed been proposed for various sorts of insects, as well as formulas which can be consumed by ingestion, but these formulas are not necessarily active for all the types of insect and the need remains to find insecticidal forms or formulations which are particularly effective for the most diverse applications, and in particular for controlling click beetles.

In addition, as regards the insecticides applied over or into the soil, it is desirable to find conditions and formulations which make it possible to obtain good efficacy at doses, which are as low as possible.

One particular reference, which is related to the control of click beetles, is US 2005/0020640 A1. In this reference, the use of fipronil as an insecticide is proposed whereby fipronil is used together with one or more moisture-retaining agents and a vegetable meal.

Although effective against a variety of pests, there are ongoing and unresolved concerns about the resistances against fipronil. Thus, there is an ongoing demand for a formulation, which is effective against click beetles and which is based on different insecticidal active ingredients.

Thus, one objective of the invention is to provide advantageous and effective compositions for controlling non-gregarious insects, which in particular abstain from the use of fipronil or related compounds.

Another object of the invention is to provide advantageous and effective compositions for controlling soil insects, especially click beetles, and more particularly click beetles in the larval state.

According to practical demand, the compositions should be easily applicable over or into the soil whereby the performance should be good in spite of low applicable doses.

It has now been found that these objects may be solved by means of specific compositions defined below.

The present invention is directed to a granular composition, comprising
(a) at least one insecticide, selected from the group consisting of an enaminocarbonyl compound, a neonicotinoid compound, a tetronic acid derivative or a tetramic acid derivative compound, a carbamate compound, an organophosphate compound, a diamide compound, a pyrethroid compound and flonicamid;
(b) optionally at least one moisture-retaining agents; and
(c) vegetable meal.

According to the present invention, the inventors have found that the above-mentioned neonicotinoid compound, an enaminocarbonyl compound, a tetronic acid derivative or a tetramic acid derivative compound, a carbamate compound, an organophosphate compound, a diamide compound, a pyrethroid compound and flonicamid or mixtures thereof can be applied in granular composition form over or into the soil of an area, which has to be cultivated, in order to control insects.

### COMPONENT (a)

### Insecticidal Active Ingredient

The composition according to the present invention comprises at least one insecticide. This at least one insecticide is selected from the group consisting of an enaminocarbonyl compound, a neonicotinoid compound, a tetronic acid derivative or a tetramic acid derivative compound, a carbamate compound, an organophosphate compound, a diamide compound, a pyrethroid compound and flonicamid.

In one preferred embodiment, the granular composition according to the present invention comprises an enaminocarbonyl compound as component (a).

Enaminocarbonyl compounds are known for example as insecticidally active compounds and can be synthesized according to known methods (e.g. EP 0 539 588 A, WO 2006/037475, WO 2007/115643, WO 2007/115644 and WO 2007/115646).

Compounds of formula (I)

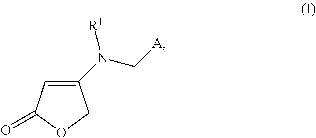

in which
A represents pyrid-2-yl or pyrid-4-yl or represents pyrid-3-yl which is optionally substituted in the 6-position by fluorine, chlorine, bromine, methyl, trifluoromethyl or trifluoromethoxy or represents pyridazin-3-yl which is optionally substituted in the 6-position by chlorine or methyl or represents pyrazin-3-yl or 2-chloro-pyrazin-5-yl or represents 1,3-thiazol-5-yl which is optionally substituted in the 2-position by chlorine or methyl, or
A represents pyrimidinyl, pyrazolyl, thiophenyl, oxazolyl, isoxazolyl, 1,2,4-oxadiazolyl, isothiazolyl, 1,2,4-triazolyl or 1,2,5-thiadiazolyl which is optionally substituted by fluorine, chlorine, bromine, cyano, nitro, C₁-C₄-alkyl (which is optionally substituted by fluorine and/or chlorine), C₁-C₃-alkylthio (which is optionally substituted by fluorine and/or chlorine), or C₁-C₃-alkylsulfonyl (which is optionally substituted by fluorine and/or chlorine),
   or
A represents

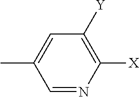

in which
X represents halogen, alkyl or halogenalkyl
Y represents halogen, alkyl, halogenalkyl, halogenalkoxy, azido or cyano
   and
R¹ represents alkyl, halogenalkyl, alkenyl, halogenalkenyl, alkinyl, cycloalkyl, cycloalkylalkyl, halogencycloalkyl, alkoxy, alkoxyalkyl, or halogencycloalkylalkyl.

In the following, preferred subgroups for the compounds of formula (I) are given.
A preferably represents 6-fluoro-pyrid-3-yl, 6-chloro-pyrid-3-yl, 6-bromo-pyrid-3-yl, 6-methyl-pyrid-3-yl, 6-trifluoromethyl-pyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl, 2-chloro-pyrimidin-5-yl, 2-trifluoromethyl-pyrimidin-5-yl, 5,6-difluoro-pyrid-3-yl, 5-chloro-6-fluoro-pyrid-3-yl, 5-bromo-6-fluoro-pyrid-3-yl, 5-iodo-6-fluoro-pyrid-3-yl, 5-fluoro-6-chloro-pyrid-3-yl, 5,6-dichloro-pyrid-3-yl, 5-bromo-6-chloro-pyrid-3-yl, 5-iodo-6-chloro-pyrid-3-yl, 5-fluoro-6-bromopyrid-3-yl, 5-chloro-6-bromo-pyrid-3-yl, 5,6-dibromo-pyrid-3-yl, 5-fluoro-6-iodo-pyrid-3-yl, 5-chloro-6-iodo-pyrid-3-yl, 5-bromo-6-iodo-pyrid-3-yl, 5-methyl-6-fluoro-pyrid-3-yl, 5-methyl-6-chloro-pyrid-3-yl, 5-methyl-6-bromo-pyrid-3-yl, 5-methyl-6-iodo-pyrid-3-yl, 5-difluoromethyl-6-fluoro-pyrid-3-yl, 5-difluoromethyl-6-chloro-pyrid-3-yl, 5-difluoromethyl-6-bromo-pyrid-3-yl or 5-difluoromethyl-6-iodo-pyrid-3-yl.
R¹ preferably represents C₁-C₅-alkyl, C₂-C₅-alkenyl, C₃-C₅-cycloalkyl, C₃-C₅-cycloalkylalkyl or alkoxy, optionally substituted by fluorine.
A more preferably represents 6-fluoro-pyrid-3-yl, 6-chloro-pyrid-3-yl, 6-bromo-pyrid-3-yl, 6-chloro-1,4-pyridazin-3-yl, 2-chloro-1,3-thiazol-5-yl, 2-chloro-pyrimidin-5-yl, 5-fluoro-6-chloro-pyrid-3-yl, 5,6-dichloro-pyrid-3-yl, 5-bromo-6-chloro-pyrid-3-yl, 5-fluoro-6-bromo-pyrid-3-yl, 5-chloro-6-bromo-pyrid-3-yl, 5,6-dibromo-pyrid-3-yl, 5-methyl-6-chloro-pyrid-3-yl, 5-chloro-6-iodo-pyrid-3-yl or 5-difluoromethyl-6-chloro-pyrid-3-yl.
R¹ more preferably represents methyl, methoxy, ethyl, propyl, vinyl, allyl, propargyl, cyclopropyl, 2-fluoro-ethyl, 2,2-difluoro-ethyl or 2-fluoro-cyclopropyl.
A even more preferably represents 6-fluoro-pyrid-3-yl, 6-chloro-pyrid-3-yl, 6-bromo-pyrid-3-yl, 5-fluoro-6-chloro-pyrid-3-yl, 2-chloro-1,3-thiazol-5-yl or 5,6-dichloro-pyrid-3-yl.
R¹ even more preferably represents methyl, cyclopropyl, methoxy, 2-fluoroethyl or 2,2-difluoro-ethyl.
A most preferably represents 6-chloro-pyrid-3-yl or 5-fluoro-6-chloro-pyrid-3-yl.
R¹ most preferably represents methyl, 2-fluoroethyl or 2,2-difluoro-ethyl. A preferred subgroup of compounds of formula (I) are those of formula (I-a)

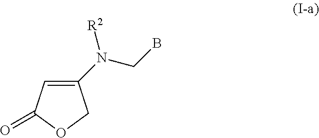

in which
B represents pyrid-2-yl or pyrid-4-yl or represents pyrid-3-yl which is optionally substituted in the 6-position by fluorine, chlorine, bromine, methyl, trifluoromethyl or trifluoromethoxy or represents pyridazin-3-yl which is optionally substituted in the 6-position by chlorine or methyl or represents pyrazin-3-yl or 2-chloro-pyrazin-5-yl or represents 1,3-thiazol-5-yl which is optionally substituted in the 2-position by chlorine or methyl,
R² represents halogenalkyl, halogenalkenyl, halogencycloalkyl or halogencycloalkylalkyl.

Preferred substituents or ranges, respectively, of formula (I-a) are given in the following.
B preferably represents 6-fluoro-pyrid-3-yl, 6-chloro-pyrid-3-yl, 6-bromo-pyrid-3-yl, 6-methyl-pyrid-3-yl, 6-trifluoromethyl-pyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl.
R² preferably represents C₁-C₅-alkyl, C₂-C₅-alkenyl, C₃-C₅-cycloalkyl or C₃-C₅-cycloalkylalkyl, substituted by fluorine.
B more preferably represents 6-fluoro-pyrid-3-yl, 6-chloro-pyrid-3-yl, 6-bromopyrid-3-yl, 6-chloro-1,4-pyridazin-3-yl or 2-chloro-1,3-thiazol-5-yl.
R² more preferably represents 2-fluoro-ethyl, 2,2-difluoro-ethyl or 2-fluoro-cyclopropyl.
B even more preferably represents 6-chloro-pyrid-3-yl.
R² even more preferably represents 2-fluoro-ethyl or 2,2-difluoro-ethyl.

A further preferred subgroup of compounds of formula (I) are those of formula (I-b)

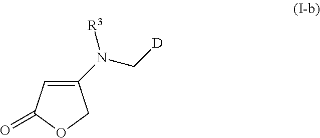

in which
D represents

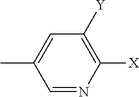

in which
X and Y are as defined above,
R³ represents hydrogen, alkyl, alkenyl, alkinyl, cycloalkyl or alkoxy.

Preferred substituents or ranges, respectively, of formula (I-b) are given in the following.
D preferably represents 5,6-difluoro-pyrid-3-yl, 5-chloro-6-fluoro-pyrid-3-yl, 5-bromo-6-fluoro-pyrid-3-yl, 5-iodo-6-fluoro-pyrid-3-yl, 5-fluoro-6-chloro-pyrid-3-yl, 5,6-dichloro-pyrid-3-yl, 5-bromo-6-chloro-pyrid-3-yl, 5-iodo-6-chloro-pyrid-3-yl, 5-fluoro-6-bromo-pyrid-3-yl, 5-chloro-6-bromo-pyrid-3-yl, 5,6-dibromo-pyrid-3-yl, 5-fluoro-6-iodo-pyrid-3-yl, 5-chloro-6-iodo-pyrid-3-yl, 5-bromo-6-iodo-pyrid-3-yl, 5-methyl-6-fluoro-pyrid-3-yl, 5-methyl-6-chloro-pyrid-3-yl, 5-methyl-6-bromo-pyrid-3-yl, 5-methyl-6-iodo-pyrid-3-yl, 5-difluoromethyl-6-fluoro-pyrid-3-yl, 5-difluoromethyl-6-chloro-pyrid-3-yl, 5-difluoromethyl-6-bromo-pyrid-3-yl or 5-difluoromethyl-6-iodo-pyrid-3-yl.
R³ preferably represents C₁-C₄-alkyl, C₂-C₄-alkenyl, C₂-C₄-alkinyl or C₃-C₄-cycloalkyl.
D more preferably represents 5-fluoro-6-chloro-pyrid-3-yl, 5,6-dichloro-pyrid-3-yl, 5-bromo-6-chloro-pyrid-3-yl, 5-fluoro-6-bromo-pyrid-3-yl, 5-chloro-6-bromo-pyrid-3-yl, 5,6-dibromo-pyrid-3-yl, 5-methyl-6-chloro-pyrid-3-yl, 5-chloro-6-iodo-pyrid-3-yl or 5-difluoromethyl-6-chloro-pyrid-3-yl.
R³ more preferably represents C₁-C₄-alkyl.
D even more preferably represents 5-fluoro-6-chloro-pyrid-3-yl or 5-fluoro-6-bromo-pyrid-3-yl.
R³ even more preferably represents methyl, ethyl, propyl, vinyl, allyl, propargyl or cyclopropyl.
D most preferably represents 5-fluoro-6-chloro-pyrid-3-yl.
R³ most preferably represents methyl or cyclopropyl.

A further preferred subgroup of compounds of formula (I) are those of formula (I-c)

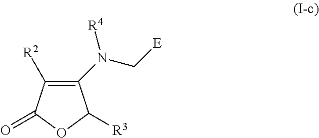

in which
E represents

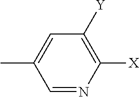

in which
X and Y are as defined above,
R⁴ represents halogenalkyl, halogenalkenyl, halogencycloalkyl or halogencycloalkylalkyl.

Preferred substituents or ranges, respectively, of formula (I-c) are given in the following.
E preferably represents 5,6-difluoro-pyrid-3-yl, 5-chloro-6-fluoro-pyrid-3-yl, 5-bromo-6-fluoro-pyrid-3-yl, 5-iodo-6-fluoro-pyrid-3-yl, 5-fluoro-6-chloro-pyrid-3-yl, 5,6-dichloro-pyrid-3-yl, 5-bromo-6-chloro-pyrid-3-yl, 5-iodo-6-chloro-pyrid-3-yl, 5-fluoro-6-bromo-pyrid-3-yl, 5-chloro-6-bromo-pyrid-3-yl, 5,6-dibromo-pyrid-3-yl, 5-fluoro-6-iodo-pyrid-3-yl, 5-chloro-6-iodo-pyrid-3-yl, 5-bromo-6-iodo-pyrid-3-yl, 5-methyl-6-fluoro-pyrid-3-yl, 5-methyl-6-chloro-pyrid-3-yl, 5-methyl-6-bromo-pyrid-3-yl, 5-methyl-6-iodo-pyrid-3-yl, 5-difluoromethyl-6-fluoro-pyrid-3-yl, 5-difluoromethyl-6-chloro-pyrid-3-yl, 5-difluoromethyl-6-bromo-pyrid-3-yl or 5-difluoromethyl-6-iodo-pyrid-3-yl.
R⁴ preferably represents C₁-C₅-alkyl, C₂-C₅-alkenyl, C₃-C₅-cycloalkyl or C₃-C₅-cycloalkylalkyl, substituted by fluorine.
E more preferably represents 5-fluoro-6-chloro-pyrid-3-yl, 5,6-dichloro-pyrid-3-yl, 5-bromo-6-chloro-pyrid-3-yl, 5-fluoro-6-bromo-pyrid-3-yl, 5-chloro-6-bromo-pyrid-3-yl, 5,6-dibromo-pyrid-3-yl, 5-methyl-6-chloro-pyrid-3-yl, 5-chloro-6-iodo-pyrid-3-yl or 5-difluoromethyl-6-chloro-pyrid-3-yl.
R⁴ more preferably represents 2-fluoro-ethyl, 2,2-difluoro-ethyl or 2-fluoro-cyclopropyl.
E even more preferably represents 5-fluoro-6-chloro-pyrid-3-yl.
R⁴ even more preferably represents 2-fluoro-ethyl or 2,2-difluoro-ethyl.

A further preferred subgroup of compounds of formula (I) are those of formula (I-d)

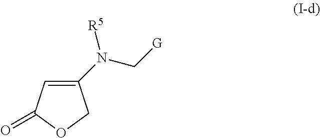

in which
G represents pyrid-2-yl or pyrid-4-yl or represents pyrid-3-yl which is optionally substituted in the 6-position by fluorine, chlorine, bromine, methyl, trifluoromethyl or trifluoromethoxy or represents pyridazin-3-yl which is optionally substituted in the 6-position by chlorine or methyl or represents pyrazin-3-yl or 2-chloro-pyrazin-5-yl or represents 1,3-thiazol-5-yl which is optionally substituted in the 2-position by chlorine or methyl, and
R⁵ represents C₁-C₄-alkyl, alkenyl, alkinyl, cycloalkyl or alkoxy.

Preferred substituents or ranges, respectively, of formula (I-d) are given in the following.
G preferably represents 6-fluoro-pyrid-3-yl, 6-chloro-pyrid-3-yl, 6-bromo-pyrid-3-yl, 6-methyl-pyrid-3-yl, 6-trifluoromethyl-pyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl.
R⁵ preferably represents C₁-C₄-alkyl, C₁-alkoxy, C₂-C₄-alkenyl, C₂-C₄-alkinyl or C₃-C₄-cycloalkyl.
G more preferably represents 6-fluoro-pyrid-3-yl, 6-chloro-pyrid-3-yl, 6-bromopyrid-3-yl, 6-chloro-1,4-pyridazin-3-yl or 2-chloro-1,3-thiazol-5-yl.
R⁵ more preferably represents methyl, methoxy, ethyl, propyl, vinyl, allyl, propargyl or cyclopropyl.
G even more preferably represents 6-chloro-pyrid-3-yl.
R⁵ even more preferably represents methyl or cyclopropyl.

The following compounds of formula (I) are especially preferred:
Compound (I-1), 4-{[(6-bromopyrid-3-yl)methyl](2-fluoroethyl)amino}furan-2(5H)-on, has the formula

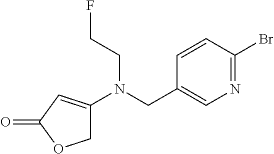

and is known from the international patent application WO 2007/115644.
Compound (I-2), 4-{[(6-fluoropyrid-3-yl)methyl](2,2-difluoroethyl)amino}furan-2(5H)-on, has the formula

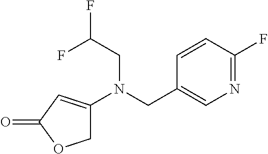

and is known from the international patent application WO 2007/115644.
Compound (I-3), 4-{[(2-chloro-1,3-thiazol-5-yl)methyl](2-fluoroethyl)amino}furan-2(5H)-on, has the formula

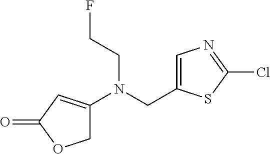

and is known from the international patent application WO 2007/115644.
Compound (I-4), 4-{[(6-chloropyrid-3-yl)methyl](2-fluoroethyl)amino}furan-2(5H)-on, has the formula

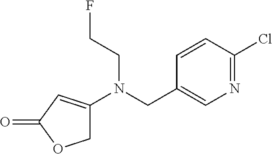

and is known from the international patent application WO 2007/115644.
Compound (I-5), 4-{[(6-chloropyrid-3-yl)methyl](2,2-difluoroethyl)amino}furan-2(5H)-on, has the formula

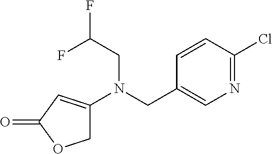

and is known from the international patent application WO 2007/115644.
Compound (I-6), 4-{[(6-chloro-5-fluoropyrid-3-yl)methyl](methyl)amino}furan-2(5H)-on, has the formula

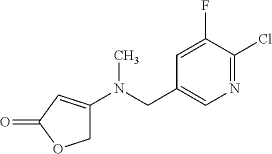

and is known from the international patent application WO 2007/115643.
Compound (I-7), 4-{[(5,6-dichloropyrid-3-yl)methyl](2-fluoroethyl)amino}furan-2(5H)-on, has the formula

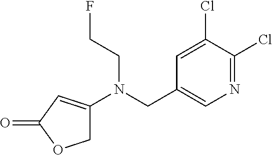

and is known from the international patent application WO 2007/115646.
Compound (I-8), 4-{[(6-chloro-5-fluoropyrid-3-yl)methyl](cyclopropyl)amino}furan-2(5H)-on, has the formula

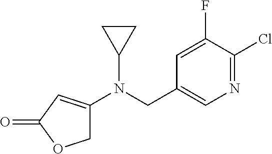

and is known from the international patent application WO 2007/115643.
Compound (I-9), 4-{[(6-chloropyrid-3-yl)methyl](cyclopropyl)amino}furan-2(5H)-on, has the formula

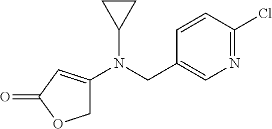

and is known from EP 0 539 588.
Compound (I-10), 4-{[(6-chloropyrid-3-yl)methyl](methyl)amino}furan-2(5H)-on, has the formula

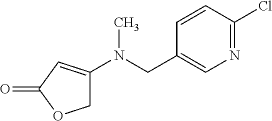

and is known from EP 0 539 588.

In one further preferred embodiment, the granular composition according to the present invention comprises a neonicotinoid compound as component (a).

In the case a neonicotinoid compound is used in the composition according to the present invention, the neonicotinoid compounds include those listed in The Pesticide Manual, 13^{th} and 14^{th} Ed.

In particular acetamiprid, clothianidin, dinotefuran, imidacloprid, imidaclothiz, nitenpyram, nithiazine, sulfoxaflor, thiacloprid, thiamethoxam, and AKD-1022 may be mentioned as a neonicotinoid compound to be used in the present invention.

As preferred neonicotinoid compounds to be used in the present invention, acetamiprid, imidacloprid, sulfoxaflor, thiamethoxam, thiacloprid and clothianidin should be mentioned.

As more preferred neonicotinoid compounds to be used in the present invention, thiacloprid and clothianidin should be mentioned.

In one further preferred embodiment, the granular composition according to the present invention comprises a tetronic acid derivative or a tetramic acid derivative compound as component (a).

In particular tetronic acid derivatives, like spirodiclofen and spiromesifen or tetramic acid derivatives, like spirotetramat may be mentioned as a compound to be used in the present invention.

Spirotetramat is known from WO 98/005638.

In one further preferred embodiment, the granular composition according to the present invention comprises a carbamate compound as component (a).

In the case a carbamate compound is used in the composition according to the present invention, the carbamate compounds include those listed in The Pesticide Manual, 13^{th} and 14^{th} Ed.

In particular alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, and xylylcarb may be mentioned as a carbamate compound to be used in the present invention.

As preferred carbamate compounds to be used in the present invention, aldicarb, benfuracarb, carbaryl, carbofuran, carbosulfan, methiocarb, methomyl, oxamyl and thiodicarb should be mentioned.

As more preferred carbamate compounds to be used in the present invention, methiocarb and thiodicarb should be mentioned.

In one further preferred embodiment, the granular composition according to the present invention comprises an organophosphate compound as component (a).

In the case an organophosphate compound is used in the composition according to the present invention, the organophosphate compounds include those listed in The Pesticide Manual, 13^{th} and 14^{th} Ed.

In particular acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl, O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion, and imicyafos may be mentioned as a organophosphate compound to be used in the present invention.

As preferred organophosphate compounds to be used in the present invention, acephate, cadusafos, chlorpyrifos (-methyl/-ethyl), dimethoate, ethoprofos, fenamiphos, fosthiazate, methamidophos, profenofos, triazophos and vamidothion should be mentioned.

As more preferred organophosphate compounds to be used in the present invention, cadusafos, chlorpyrifos (-methyl/-ethyl), ethoprofos, fenamiphos, fosthiazate, methamidophos and triazophos should be mentioned.

In one further preferred embodiment, the granular composition according to the present invention comprises a diamide compound as component (a).

In the case a diamide compound is used in the composition according to the present invention, the diamide compounds include those listed in The Pesticide Manual, 13^{th} and 14^{th} Ed.

In particular may be mentioned Ryanodine receptor effectors, for example diamides, flubendiamide, (R),(S)-3-chloro-N¹-{2-methyl-4-[1,2,2,2-tetrafluoro-1-(trifluoromethyl)-ethyl]-phenyl}-N²-(1-methyl-2-methylsulphonylethyl)phthalamide, chloranthraniliprole (rynaxypyr), or cyanthraniliprole (cyazypyr) as a diamide compound to be used in the present invention.

As preferred diamide compounds to be used in the present invention, flubendiamide, chloranthraniliprole and cyanthraniliprole should be mentioned.

As more preferred diamide compound to be used in the present invention, flubendiamide and chloranthraniliprole should be mentioned.

Flubendiamide and (R),(S)-3-chloro-N¹-{2-methyl-4-[1,2,2,2-tetrafluoro-1-(trifluoromethyl)-ethyl]-phenyl}-N²-(1-methyl-2-methylsulphonylethyl)phthalamide are known form the European patent application EP 1 006 107, chloranthraniliprole (rynaxypyr) is known from WO 03/015519, cyanthraniliprole (cyazypyr) is known from WO 04/067528.

In one further preferred embodiment, the granular composition according to the present invention comprises a pyrethroid compound as component (a).

In the case a pyrethroid compound is used in the composition according to the present invention, the pyrethroid compounds include those listed in The Pesticide Manual, 13⁶ and 14^{th} Ed.

In particular may be mentioned acrinathrin, allethrin (d-cis-trans, d-trans), beta-cyfluthrin, bifenthrin, bioallethrin, bioallethrin S-cyclopentyl isomer, bioethanomethrin, biopermethrin, bioresmethrin, chlovaporthrin, (cis)-cypermethrin, cis-resmethrin, cis-permethrin, clocythrin, cycloprothrin, cyfluthrin, lambda-cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R trans isomer), prallethrin, profluthrin, protrifenbute, pyresmethrin, resmethrin, RU 15525, silafluofen, tau-fluvalinate, tefluthrin, terallethrin, tetramethrin (-1R-isomer), tralomethrin, transfluthrin, ZXI 8901, pyrethrin (pyrethrum), eflusilanat as a pyrethroid compound to be used in the present invention.

As preferred pyrethroid compounds to be used in the present invention, beta-cyfluthrin, (cis)-cypermethrin, deltamethrin, lambda-cyhalothrin, tau-fluvalinate, tefluthrin and transfluthrin should be mentioned.

As more preferred pyrethroid compounds to be used in the present invention, beta-cyfluthrin, deltamethrin, tefluthrin and transfluthrin should be mentioned.

In one further preferred embodiment, the granular composition according to the present invention comprises flonicamid as component (a).

Flonicamid is known as insecticidal compound from European patent application EP-B 580 374.

A mixture of these insecticides can also be envisaged in the context of the present invention.

In particular may be mentioned mixtures comprising at least one neonicotinoid compound and at least one enaminocarbonyl compound and/or at least one neonicotinoid compound and at least one tetronic acid derivative or a tetramic acid derivative and/or at least one neonicotinoid compound and at least one carbamate compound and/or at least one neonicotinoid compound and at least one organophosphate compound and/or at least one neonicotinoid compound and at least one Ryanodine receptor effector, e.g. diamide and/or at least one neonicotinoid compound and at least one pyrethroid compound and/or at least one neonicotinoid compound and at least one neonicotinoid compound.

In particular may also be mentioned mixtures comprising at least one enaminocarbonyl compound and at least one enaminocarbonyl compound and/or at least one enaminocarbonyl compound and at least one tetronic acid derivative or a tetramic acid derivative and/or at least one enaminocarbonyl compound and at least one carbamate compound and/or at least one enaminocarbonyl compound and at least one organophosphate compound and/or at least one enaminocarbonyl compound and at least one Ryanodine receptor effector, e.g. diamide and/or at least one enaminocarbonyl compound and at least one pyrethroid compound.

In particular may also be mentioned mixtures comprising at least one tetronic acid derivative or a tetramic acid derivative compound and at least one enaminocarbonyl compound and/or at least one tetronic acid derivative or a tetramic acid derivative compound and at least one tetronic acid derivative or a tetramic acid derivative and/or at least one tetronic acid derivative or a tetramic acid derivative compound and at least one carbamate compound and/or at least one tetronic acid derivative or a tetramic acid derivative compound and at least one organophosphate compound and/or at least one tetronic acid derivative or a tetramic acid derivative compound and at least one Ryanodine receptor effector, e.g. diamide and/or at least one tetronic acid derivative or a tetramic acid derivative compound and at least one pyrethroid compound.

In particular may also be mentioned mixtures comprising at least one carbamate compound and at least one enaminocarbonyl compound and/or at least one carbamate compound and at least one tetronic acid derivative or a tetramic acid derivative and/or at least one carbamate compound and at least one carbamate compound and/or at least one carbamate compound and at least one organophosphate compound and/or at least one carbamate compound and at least one Ryanodine receptor effector, e.g. diamide and/or at least one carbamate compound and at least one pyrethroid compound.

In particular may also be mentioned mixtures comprising at least one organophosphate compound and at least one enaminocarbonyl compound and/or at least one organophosphate compound and at least one tetronic acid derivative or a tetramic acid derivative and/or at least one organophosphate compound and at least one carbamate compound and/or at least one organophosphate compound and at least one organophosphate compound and/or at least one organophosphate compound and at least one Ryanodine receptor effector, e.g. diamide and/or at least one organophosphate compound and at least one pyrethroid compound.

In particular may also be mentioned mixtures comprising at least one Ryanodine receptor effector, e.g. diamide compound and at least one enaminocarbonyl compound and/or at least one Ryanodine receptor effector, e.g. diamide compound and at least one tetronic acid derivative or a tetramic acid derivative and/or at least one Ryanodine receptor effector, e.g. diamide compound and at least one carbamate compound and/or at least one Ryanodine receptor effector, e.g. diamide compound and at least one organophosphate compound and/or at least one Ryanodine receptor effector, e.g. diamide compound and at least one Ryanodine receptor effector, e.g. diamide and/or at least one Ryanodine receptor effector, e.g. diamide compound and at least one pyrethroid compound.

In particular may also be mentioned mixtures comprising at least one pyrethroid compound and at least one enaminocarbonyl compound and/or at least one pyrethroid compound and at least one tetronic acid derivative or a tetramic acid derivative and/or at least one pyrethroid compound and at least one carbamate compound and/or at least one pyrethroid compound and at least one organophosphate compound and/or at least pyrethroid compound and at least one Ryanodine receptor effector, e.g. diamide and/or at least one pyrethroid compound and at least one pyrethroid compound.

As preferred mixtures to be used in the present invention, mixtures comprising at least one neonicotinoid compound and at least one pyrethroid compound, mixtures comprising at least one neonicotinoid compound and at least one neonicotinoid compound, mixtures comprising at least one neonicotinoid compound and at least one carbamate compound should be mentioned.

As more preferred mixtures to be used in the present invention, mixtures comprising at least one neonicotinoid compound and at least one pyrethroid compound should be mentioned.

As more preferred mixtures to be used in the present invention, mixtures comprising at least one neonicotinoid compound and at least one neonicotinoid compound should be mentioned.

As more preferred mixtures to be used in the present invention, mixtures comprising at least one neonicotinoid compound and at least one carbamate compound should be mentioned.

As more preferred mixtures to be used in the present invention, mixtures comprising at least one neonicotinoid compound selected from the group consisting of acetamiprid, imidacloprid, sulfoxaflor, thiamethoxam, thiacloprid, and clothianidin and at least one carbamate compound selected from the group consisting of methiocarb and thiodicarb should be mentioned.

As more preferred mixtures to be used in the present invention, mixtures comprising at least one neonicotinoid compound selected from the group consisting of acetamiprid, imidacloprid, sulfoxaflor, thiamethoxam, thiacloprid, and clothianidin and at least one pyrethroid compound selected from the group consisting of beta-cyfluthrin, cis-cypermethrin, deltamethrin, tau-fluvalinate, tefluthrin and transfluthrin should be mentioned.

As preferred mixtures to be used in the present invention, the following mixtures of insecticides should be mentioned: imidacloprid and clothianidin, clothianidin and thiacloprid and imidaclopid and thiacloprid.

Especially preferred mixtures to be used in the present invention comprise clothianidin and beta-cyfluthrin, clothianidin and cis-cypermethrin, clothianidin and deltamethrin, clothianidin and tau-fluvalinat, clothianidin and tefluthrin, clothianidin and transfluthrin, imidacloprid and beta-cyfluthrin, imidacloprid and cis-cypermethrin, imidacloprid and deltamethrin, imidacloprid and tau-fluvalinat, imidacloprid and tefluthrin, imidacloprid and transfluthrin, thiacloprid and beta-cyfluthrin, thiacloprid and cis-cypermethrin, thiacloprid and deltamethrin, thiacloprid and tau-fluvalinat, thiacloprid and tefluthrin, thiacloprid and transfluthrin, thiamethoxam and beta-cyfluthrin, thiamethoxam and cis-cypermethrin, thiamethoxam and deltamethrin, thiamethoxam and tau-fluvalinat, thiamethoxam and tefluthrin, thiamethoxam and transfluthrin, thiacloprid and imidacloprid, thiacloprid and clothianidin, sulfoxaflor and beta-cyfluthrin, sulfoxaflor and cis-cypermethrin, sulfoxaflor and deltamethrin, sulfoxaflor and tau-fluvalinat, sulfoxaflor and tefluthrin, sulfoxaflor and transfluthrin, clothianidin and methiocarb, imidacloprid and methiocarb, thiacloprid and methiocarb, sulfoxaflor and methiocarb, clothianidin and thiodicarb, imidacloprid and thiodicarb, thiacloprid and thiodicarb, sulfoxaflor and thiodicarb.

As especially preferred mixtures to be used in the present invention, mixtures comprising clothianidin and transfluthrin, imidacloprid and transfluthrin, thiacloprid and transfluthrin and thiamethoxam and transfluthrin, should be mentioned.

As also especially preferred mixtures to be used in the present invention, mixtures comprising clothianidin and methiocarb, imidacloprid and methiocarb, thiacloprid and methiocarb and thiamethoxam and methiocarb, should be mentioned.

Besides mixtures of the above-mentioned insecticides, it is possible to use further mixtures of at least one of the above-mentioned insecticides together with at least one further insecticide selected from the group consisting of fiproles such as fipronil, pyrethroids such as deltamethrin, transfluthrin, beta-cyfluthrin, carbamates such as thiodicarb, aldicarb and methiocarb; and organophosphorous esters such as chlorpyriphos

### COMPONENT (b)

### Moisture-Retaining Agent

According to the present invention, a moisture-retaining agent may be used within the granular composition, which is preferably of organic nature.

Among the moisture-retaining agents of an organic nature, there may be mentioned the macromolecular hydrophilic derivatives of plant origin, and in particular the cellulosic hydrophilic derivatives, and more particularly cellulose, but also one or more disintegrating agents. It may be advantageous to use these compounds in particular when meals such as hard wheat meals are used in the granules. Disintegrating agents include: starch, sodium carboxym-ethyl starch, cellulose such as microcrystalline cellulose; modified celluloses such as sodium carboxymethylcellulose; bentonite, aluminium and magnesium silicate; sodium polynaphthalenesulphonate, sodium dodecylbenzenesulphonate, sodium dioctylsulphosuccinate, lignin sulphonate; a saccharide derivative such as lactose, fructose, sucrose, mannitol, dextrose; a cross-linked derivative of polyvinylpyrrolidone.

A mixture of these moisture-retaining agents can also be envisaged in the context of the present invention. However, in one very specific preferred embodiment of the present invention it is preferred that no moisture-retaining agent is present in the respective composition.

### COMPONENT (c)

### Vegetable Meals

Among the vegetable meals, which can be used in the composition according to the present invention, there may be mentioned the meals derived from the grinding of cereal grains such as wheat, barley, rye, triticale, oats, rice, sorghum, soybean, maize, whereby the preferred meal being that based on wheat.

The foregoing bait is in particular applicable with various types of wheat flour such as hard flour, quasi-hard flour, medium flour and soft flour.

A mixture of these vegetable meals can also be envisaged in the context of the present invention.

In one embodiment, the composition according to the present invention comprises the insecticide according to the definition of component (a) in an amount of from 0.001 to 5 wt.-%, preferably of from 0.05 to 1 wt.-% and still more preferably of from 0.05 to 0.5 wt.-%, based on the total weight of the respective composition

In a further embodiment, the composition according to the present invention comprises the moisture-retaining agent according to the definition of component (b)—if present—in an amount of from 0.05 to 10 wt.-%, preferably of from 0.10 to 5 wt.-% and still more preferably of from 0.10 to 3 wt.-%, based on the total weight of the respective composition.

In a further embodiment, the composition according to the present invention comprises the vegetable meals according to the definition of component (c) in an amount of from 40 to 99 wt.-%, preferably of from 50 to 98 wt.-% and still more preferably of from 70 to 97 wt.-%, based on the total weight of the respective composition.

The above-mentioned amounts of the components (a) to (c) can be combined in any combination of preferred amounts.

### Further Ingredients

According to a further embodiment of the composition according to the invention, the composition may also comprise from 3 to 30 wt.-%, preferably from 4 to 20 wt.-% of sugars. The sugars are chosen in particular from mono-, oligo- or polyorganosaccharides, especially from sucrose, lactose, fructose, dextrose, glucose or alternatively molasses or honey

The compositions which are the subject of the invention may also comprise a preservative preventing the degradation of the meals, such as sodium benzoate, 1,2-benzisothiazolin-3-one, benzoic acid, parahydroxybenzoic acid and its ester derivatives and its alkali or alkaline-earth metal salts, in particular the sodium salt, 2-phenylphenol and its alkali or alkaline-earth metal salts, in particular the sodium salt, and paranitrophenol. In the case a preservative preventing the degradation of the meals is present in the present granular composition, the amount of this preservative preventing the degradation of the meals is in the range of 0.01 to 1 wt.-%.

Other formulation additives may be used such as binding, agglomerating, appetite-enhancing, agglutinating, gelling, swelling or antiadherent agents, milling aids, wetting agents, dispersing agents, dyes/dye stuffs, anti-dust agents, anti-electrostatic agents, antimicrobiocide agents and the like. These additives may be present in the respective compositions in an amount of from 0.001 to 0.5 wt.-%.

### Constitution of the Composition

The formulations according to the invention are generally in the form of granules. The size of the granules is not specifically restricted. However, from the practical point of view it is preferred that the granules have a size of advantageously between 0.1 mm and 3 cm, preferably between 0.5 and 4 mm. These granules are advantageously insoluble in water (in the sense that they resist disintegration with water) basically based on the presence of the vegetable meals.

### Preparation of the Composition

The compositions according to the invention may be prepared by simply mixing the various constituents, preferably by extrusion or compression in the cold or hot state according to any granulation or pelleting technique known per se. For the production of such granules, reference can be easily made to the European patent application published under the number EP 0 575 838 A and/or to other techniques, for example extrusion techniques, known to persons skilled in the art.

In a preferred embodiment, the method for preparing the respective composition may further comprise a step of micronising either in a dry or wet system. The micronisation may refer to the complete mixture but preferably only to the active ingredient and suitable ingredients mentioned above. In the sense of the present invention, micronising is understood as the reduction of particles to a size of less than 10 μm by dry or wet milling processes.

### Method for Controlling Insects

The invention also relates to a method of protecting crops from insects, especially click beetles, characterized in that an effective quantity of a composition in the form of granules, comprising at least one insecticide, selected from the group consisting of a neonicotinoid compound, an enaminocarbonyl compound, a tetronic acid derivative or a tetramic acid derivative compound, a carbamate compound, an organophosphate compound, a diamide compound, a pyrethroid compound and flonicamid is applied over or into the soil (preferably into the soil) of the area which has to be cultivated.

In respect to specific embodiments of the process according to the present invention, reference is made to the above.

The invention thus relates more particularly to a method of protecting cereal, preferably maize or beet or sunflower or potato or rape. The application of the formulations according to the invention takes place advantageously before sowing the said crop, or simultaneously with this sowing.

The application of the granular proceeds preferably at planting as in furrow treatment, planting row treatment, and side row treatment.

The invention also relates to a method of controlling insects, especially click beetles, characterized in that an effective quantity of one of the compositions according to the invention is applied onto or into the soil (preferably into the soil) where they are present or are likely to be present.

As effective quantity, quantities of composition corresponding to a dose of compound (a), insecticide selected from the group consisting of a neonicotinoid compound, an enaminocarbonyl compound, a tetronic acid derivative or a tetramic acid derivative compound, a carbamate compound, an organophosphate compound, a diamide compound, a pyrethroid compound and flonicamid, of between 1 and 500 g/ha, preferably between 1 and 250 g/ha, more preferably between 1 and 150 g/ha, still more preferably between 1 and 100 g/ha, most preferably between 1 and 50 g/ha, still most preferably between 3 and 40 g/ha are often used.

A specific characteristic of the method of controlling insects according to the invention consists in the application, onto or into the soil, of a composition providing a dose, which is non-lethal through contact but lethal through ingestion.

In other words, in the specific case of click beetles, the method consists in killing the click beetles by application of a dose, which is non-lethal through contact but lethal through ingestion. A hypothesis for the good efficacy of the method of treatment according to the invention, which makes it possible to greatly reduce the applicable doses of compounds according to the definition under (a) in particular, is based on the fact that once the bait according to the invention has caused the death of a click beetle, the latter can itself serve as bait for other click beetles, which therefore also ingest a product (dead click beetle) containing the insecticide.

For the purposes of the present text, the words insecticide and insect should be taken in their broad ordinary sense and not in their strictly scientific (zoological) sense. Accordingly, the term insect is understood to mean any animal of a very small size such as arthropods (insects in the strict and zoological sense, arachnids, myriapods) and nematodes.

As soil insects against which the invention is particularly effective, there may be mentioned for example:

The Coleoptera (wireworms (Agriotes spp.), false wireworms, white grubs) such as for example:
Agriotes lineatus (European click beetle, Elateridae),
Agriotes sordidus (European click beetle, Elateridae),
Agriotes obscurus (European click beetle, Elateridae),
Agriotes sputator (European click beetle, Elateridae),

### Athous spp. (Elateridae),

Atomaria linearis (Cryptophagidae)
Melolontha spp., Popilia spp. (white grubs, Scarabaeidae),

### Bothynoderes spp.

Limonius spp. (US click beetle),
Melanotus spp. (US click beetle),
Diabrotica spp. (cornroot worms, Chrysomelidae),
Phyllotreta spp., Psylliodes spp. (flea beetles, Halticinae)
Tanymecus pallidus (beet leaf weevil, Curculion-idae).
The Lepidoptera (Noctuidae) such as:
Autographa spp., Mamestra spp., Agrotis spp. (cutworms, grey grubs), Euxoa spp. (cutworms, grey grubs), Spodoptera spp. (Spodoptera exigua, Spodoptera littorlis).
The Diptera such as

### Tipula spp.

### The Myriapoda (Myriapoda):

### Diplopoda=Millipedes,

### Centipede.

Among the soil click beetles against which the invention is particularly effective, there may be mentioned Agriotes spp., Athous spp., Limonius spp.

The granules according to the invention are advantageously inserted into the soil at a depth of between 1 and 5 cm.

The compositions according to the invention are particularly advantageous in that they allow the use of lower doses of active product than similar known compositions.

The following examples illustrate the invention without however constituting a limitation thereto.

### Preparation Example

A typical recipe of the granular baits consists of

| | |
|---|---|
| 0.625% | active ingredient (such as thiacloprid) |
| 0.134% | aluminiumoxide |
| 0.045% | alkylarylsulfonate |
| 0.018% | diisobutylnaphthalinsulfonate |
| 0.063% | kaolin |
| 99.115% | wheat flour |

One possibility to granulate the formulation is via a wet extrusion process.

All components except the wheat flour are separately mixed and micronised prior to mixing with the wheat flour. The whole mixture is then combined with an appropriate amount of water that is necessary to form a dough. This is finally extruded, cut and dried.

### Application Example

### Diabrotica Balteata Test (DIABBA), Larvae in the Soil

Bait granules respectively granules containing the active ingredient were deposited in the open furrow, sown with 4 maize seeds per pot and filled with soil. 3 days after sowing larvae of the Banded Cucumber Beetle (Diabrotica balteata) are placed in the soil.

After the desired period of time the level of feeding expressed in % is determined. The level of activity is calculated on the basis of the feeding rate compared to the control.

In this test, for example, the following bait granules respectively granules show a superior level of activity compared to the prior state of the art:

TABLE 1
Diabrotica balteata - Test, bait granules

| Bait granule | a.i. concentration in % | efficacy in % after 14 d |
|---|---|---|
| Clothianidin GB | 0.625 | 98.5 |
| Thiacloprid GB | 0.625 | 98.5 |
| Compound (I-5) GB | 0.625 | 74.1 |
| Fipronil GB | 0.625 | 0 |
| State of the art | | |

TABLE 2
Diabrotica balteata - Test, granules

| Granule | a.i. concentration in % | efficacy in % after 14 d |
|---|---|---|
| Clothianidin GR | 0.625 | 85.2 |
| Thiacloprid GR | 0.625 | 68.2 |
| Compound (I-5) GR | 0.625 | 60.2 |
| Fipronil GR | 0.625 | 0 |
| State of the art | | |

Table 1 shows the superiority of the bait granules according to the present invention as compared with the state of the art US 2005/0020640 A1.

A comparison of the bait granules of Table 1 with the granules of Table 2 shows the higher attractiveness of the bait granules. In particular, this means that the bait granules are also more attractive than the maize seed itself, which was not foreseeable.

1. Insecticidal granular composition, comprising
(a) at least one insecticide, selected from the group consisting of an enaminocarbonyl compound, a neonicotinoid, a tetronic acid derivative or a tetramic acid derivative compound, a carbamate compound, an organophosphate compound, a diamide compound, a pyrethroid compound and flonicamid;
(b) optionally at least one moisture-retaining agent; and
(c) vegetable meal.

2. Insecticidal granular composition according to claim 1, whereby the composition comprises the insecticide according to the definition of component (a) in an amount of from 0.001 to 5 wt.-%, based on the total weight of the respective composition.

3. Insecticidal granular composition according to claim 1, whereby the composition comprises the moisture-retaining agent according to the definition of component (b) in an amount of from 0.05 to 10 wt.-%, based on the total weight of the respective composition.

4. Insecticidal granular composition according to claim 1, whereby the composition comprises the vegetable meal in an amount of from 40 to 99 wt.-%, based on the total weight of the respective composition.

5. Insecticidal granular composition according to claim 1, whereby the insecticide is selected from the group consisting of enaminocarbonyl compounds.

6. Insecticidal granular composition according to claim 5, whereby the insecticide is selected from the group consisting of enaminocarbonyl compounds of formula (I) 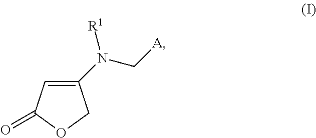
in which
A represents pyrid-2-yl or pyrid-4-yl or represents pyrid-3-yl which is optionally substituted in the 6-position by fluorine, chlorine, bromine, methyl, trifluoromethyl or trifluoromethoxy or represents pyridazin-3-yl which is optionally substituted in the 6-position by chlorine or methyl or represents pyrazin-3-yl or 2-chloro-pyrazin-5-yl or represents 1,3-thiazol-5-yl which is optionally substituted in the 2-position by chlorine or methyl, or
A represents pyrimidinyl, pyrazolyl, thiophenyl, oxazolyl, isoxazolyl, 1,2,4-oxadiazolyl, isothiazolyl, 1,2,4-triazolyl or 1,2,5-thiadiazolyl which is optionally substituted by fluorine, chlorine, bromine, cyano, nitro, C₁-C₄-alkyl (which is optionally substituted by fluorine and/or chlorine), C₁-C₃-alkylthio (which is optionally substituted by fluorine and/or chlorine), or C₁-C₃-alkylsulfonyl (which is optionally substituted by fluorine and/or chlorine),
or
A represents 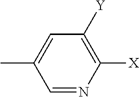
in which
X represents halogen, alkyl or halogenalkyl
Y represents halogen, alkyl, halogenalkyl, halogenalkoxy, azido or cyano
and
R¹ represents alkyl, halogenalkyl, alkenyl, halogenalkenyl, alkinyl, cycloalkyl, cycloalkylalkyl, halogencycloalkyl, alkoxy, alkoxyalkyl, or halogencycloalkylalkyl;
or of compounds of formula (I-a) 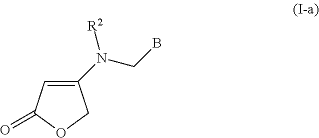
in which
B represents pyrid-2-yl or pyrid-4-yl or represents pyrid-3-yl which is optionally substituted in the 6-position by fluorine, chlorine, bromine, methyl, trifluoromethyl or trifluoromethoxy or represents pyridazin-3-yl which is optionally substituted in the 6-position by chlorine or methyl or represents pyrazin-3-yl or 2-chloro-pyrazin-5-yl or represents 1,3-thiazol-5-yl which is optionally substituted in the 2-position by chlorine or methyl,
R² represents halogenalkyl, halogenalkenyl, halogencycloalkyl or halogencycloalkylalkyl;
or of compounds of formula (I-b) 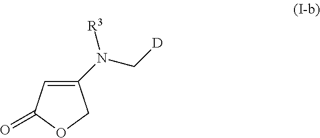
in which
D represents 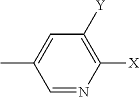
in which
X and Y are as defined above,
R³ represents hydrogen, alkyl, alkenyl, alkinyl, cycloalkyl or alkoxy;
or of compounds of formula (I-c) 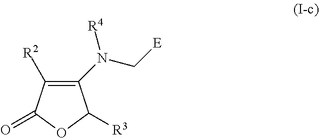
in which
E represents 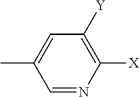
in which
X and Y are as defined above,
R⁴ represents halogenalkyl, halogenalkenyl, halogencycloalkyl or halogencycloalkylalkyl;
or of compounds of formula (I-d) 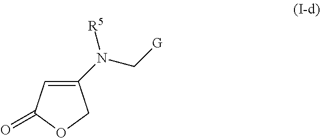
in which
G represents pyrid-2-yl or pyrid-4-yl or represents pyrid-3-yl which is optionally substituted in the 6-position by fluorine, chlorine, bromine, methyl, trifluoromethyl or trifluoromethoxy or represents pyridazin-3-yl which is optionally substituted in the 6-position by chlorine or methyl or represents pyrazin-3-yl or 2-chloro-pyrazin-5-yl or represents 1,3-thiazol-5-yl which is optionally substituted in the 2-position by chlorine or methyl, and
R⁵ represents C₁-C₄-alkyl, alkenyl, alkinyl, cycloalkyl or alkoxy.

7. Insecticidal granular composition according to claim 6, whereby the insecticide is selected from the group consisting of
4-{[(6-bromopyrid-3-yl)methyl](2-fluoroethyl)amino}furan-2(5H)-on,
4-{[(6-fluoropyrid-3-yl)methyl](2,2-difluoroethyl)amino}furan-2(5H)-on,
4-{[(2-chloro-1,3-thiazol-5-yl)methyl](2-fluoroethyl)amino}furan-2(5H)-on,
4-{[(6-chloropyrid-3-yl)methyl](2-fluoroethyl)amino}furan-2(5H)-on,
4-{[(6-chloropyrid-3-yl)methyl](2,2-difluoroethyl)amino}furan-2(5H)-on,
4-{[(6-chloro-5-fluoropyrid-3-yl)methyl](methyl)amino}furan-2(5H)-on,
4-{[(5,6-dichloropyrid-3-yl)methyl](2-fluoroethyl)amino}furan-2(5H)-on,
4-{[(6-chloro-5-fluoropyrid-3-yl)methyl](cyclopropyl)amino}furan-2(5H)-on,
4-{[(6-chloropyrid-3-yl)methyl](cyclopropyl)amino}furan-2(5H)-on,
(I-10), 4-{[(6-chloropyrid-3-yl)methyl](methyl)amino}furan-2(5H)-on.

8. Insecticidal granular composition according to claim 1, whereby the insecticide is selected from the group consisting of neonicotinoid compounds.

9. Insecticidal granular composition according to claim 8, whereby the insecticide is selected from the group consisting of acetamiprid, clothianidin, dinotefuran, imidacloprid, imidaclothiz, nitenpyram, nithiazine, sulfoxaflor, thiacloprid, thiamethoxam, and AKD-1022.

10. Insecticidal granular composition according to claim 1, whereby the vegetable meals are selected from the meals derived from the grinding of cereal grains such as wheat, barley, rye, triticale, oats, rice, sorghum, soybean and maize.

11. Method of controlling insects, characterized in that an effective quantity of a composition according to claim 1 in the form of granules having a size of between 0.1 mm and 3 cm is applied over or into the soil of the area which has to be cultivated.

12. Method according to claim 11, characterized in that an effective quantity of one of the compositions according to the invention is used for controlling insects, especially click beetles.

13. Method according to claim 11, characterized in that the effective quantity of composition corresponds to a dose of the component (a) of between 1 and 50 g/ha, preferably between 3 and 40 g/ha.

14. Method of controlling insects which consists in the application, onto or into the soil, of a composition according to claim 1 providing a dose to the insects which is non-lethal through contact but lethal through ingestion.

15. Method according to claim 14, applicable to click beetles.

16. Use of a composition according to claim 1 for controlling insects.

17. Use according to claim 16, wherein the insects are click beetles.
